(19) United States
(12) Patent Application Publication
(10) Pub. No.: US 2020/0362665 A1
(43) Pub. Date: Nov. 19, 2020

(54) SEQUENCER FOR WELLHEAD DEVICE

(71) Applicant: C&J SPEC-RENT SERVICES INC., Houston, TX (US)

(72) Inventors: Charles Stewart, Alvin, TX (US); Vanessa Michelle Reyes, Houston, TX (US); Kevin Zanca, Houston, TX (US)

(73) Assignee: C&J SPEC-RENT SERVICES INC., Houston, TX (US)

(21) Appl. No.: 16/411,460

(22) Filed: May 14, 2019

(51) Int. Cl. E21B 34/02; E21B 33/068; E21B 23/04; F15B 11/20

(52) U.S. Cl. CPC E21B 34/02; F15B 11/20; E21B 23/04; E21B 33/068

(57) ABSTRACT

A wellhead system includes a sequence valve in fluid communication with a wellhead device having a first hydraulic actuation device and a second hydraulic actuation device. The sequence valve includes a valve element configured to direct flow to the first hydraulic actuation device in a closed position and to direct flow to the second hydraulic actuation device in an open position. The sequence valve can actuate the second hydraulic actuation device after fully actuating the first hydraulic actuation device. Because the sequence valve can control the order of actuation of the actuation devices, the sequence valve can simplify the operation of the wellhead device and prevent incomplete or improper actuation of the wellhead device. The sequence valve can be utilized in remote and high pressure applications. Because of this, the sequence valve can provide reliable operation in various configurations.

### TECHNICAL FIELD

The present disclosure relates generally to wellhead systems, and, more particularly, to control valves for use with wellhead systems.

### BACKGROUND

Wellhead systems provide a surface interface to allow tools and equipment to be coupled with an oil and gas well. A wellhead device can utilize various connection mechanisms to facilitate the attachment and removal of tools and equipment such as a nightcap or a lubricator. In some applications, a wellhead device can include actuators to allow tools and equipment to be secured and released remotely. For example, a wellhead device can include one or more hydraulic actuators to secure or release equipment. Wellhead devices (such as RigLock by FHE) can include multiple hydraulic actuators that are engaged or disengaged in steps or sequence to secure or release a component from the wellhead. During operation of the wellhead device, operators can manually direct hydraulic fluid flow to each of the actuators in sequence to engage or disengage the component from the wellhead.

Wellhead devices can be used in high pressure applications and may be actuated remotely without a line-of-sight. However, one drawback of conventional operation of wellhead devices is that wellhead devices can be partially or improperly actuated, preventing an adequate seal between the wellhead device and the component to be secured. For example, without visual confirmation, an operator may only partially actuate a first actuator prior to actuating the second actuator of the wellhead device, preventing the wellhead device from adequately sealing against the component. Such an inadequate seal can lead to leakage or a risk of blowout.

Timed actuation sequences may be used in an effort to avoid certain problems during the operation of wellhead devices, but timed actuation sequences suffer from additional drawbacks. In some applications, the amount of time required to completely actuate the wellhead device can vary as the pressure and viscosity of the hydraulic fluid change, which may limit the usefulness of timed actuation sequences. For example, the time for complete actuation can vary as temperatures (including extremely low temperatures, such as −20° F.) change with location, weather, and the time of day. Therefore, what is needed is an apparatus, system or method that addresses one or more of the foregoing issues, among one or more other issues.

### SUMMARY OF THE INVENTION

A wellhead system is disclosed. The wellhead system includes a sequence valve in fluid communication with a wellhead device having a first hydraulic actuation device and a second hydraulic actuation device. The sequence valve includes a valve element configured to direct flow to the first hydraulic actuation device in a closed position and to direct flow to the second hydraulic actuation device in an open position. The sequence valve can actuate the second hydraulic actuation device after fully actuating the first hydraulic actuation device. Because the sequence valve can control the order of actuation of the actuation devices, the sequence valve can simplify the operation of the wellhead device and prevent incomplete or improper actuation of the wellhead device. The sequence valve can be utilized in remote and high pressure applications. Because of this, the sequence valve can provide reliable operation in various configurations.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1A is a schematic view of an embodiment of a wellhead system.

FIG. 1B is a schematic view of the wellhead system of FIG. 1A in a releasing configuration.

FIG. 2A is a schematic view of an embodiment of a wellhead system.

FIG. 2B is a schematic view of the wellhead system of FIG. 2A in a releasing configuration.

FIG. 3A is a schematic view of an embodiment of a wellhead system.

FIG. 3B is a schematic view of the wellhead system of FIG. 3A in a releasing configuration.

FIG. 4A is a schematic view of an embodiment of a wellhead system.

FIG. 4B is a schematic view of the wellhead system of FIG. 4A in a releasing configuration.

FIG. 5A is a schematic view of an embodiment of a wellhead system.

FIG. 5B is a schematic view of the wellhead system of FIG. 5A in a releasing configuration.

### DETAILED DESCRIPTION

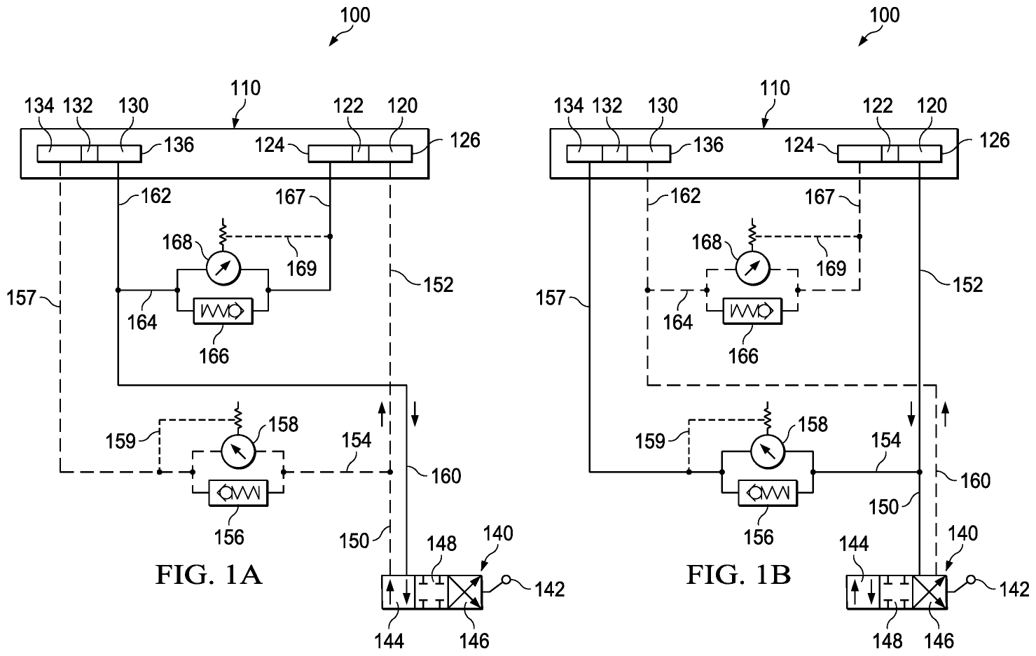

FIG. 1A is a schematic view of an embodiment of a wellhead system 100. In the depicted example, the wellhead system 100 facilitates the connection and disconnection of components, such as a nightcap or lubricator, with the wellhead of an oil and gas well.

As illustrated, the wellhead system 100 includes a wellhead locking device 110 coupled to the wellhead to permit the remote connection or disconnection of wellhead components. Optionally, the wellhead system 100 can utilize commercially available wellhead locking devices 110 such as RigLock by FHE. In some embodiments, the wellhead locking device 110 includes locking mechanisms, such as the first locking mechanism 120 and the second locking mechanism 130, to lock or release wellhead components from the wellhead locking device 110.

For example, the first locking mechanism 120 can include a plurality of rotatable cams that actuate or rotate in a first direction (e.g. inward) to engage, retain, or lock a wellhead component and can rotate in a second direction (e.g. outward) to release the wellhead component. Optionally, the second locking mechanism 130 can include a safety ring that actuates or translates downward to engage, retain, or lock the first locking mechanism 120 in a locked position and can translate upward to permit the first locking mechanism 120 to rotate to release the wellhead component. As may be appreciated, the first locking mechanism 120 and the second locking mechanism 130 can use any suitable locking mechanism.

As described, the first locking mechanism 120 and the second locking mechanism 130 can be configured to cooperatively operate in steps or sequence to engage a wellhead component. For example, to lock or engage a wellhead component with the wellhead locking device 110, the first locking mechanism 120 can receive the wellhead component and then rotate the plurality of rotatable cams to lock the wellhead component. After the first locking mechanism 120 has been fully actuated, the second locking mechanism 130 can engage a safety ring to retain the first locking mechanism 120 in the locked position. During operation, if the first locking mechanism 120 is not fully actuated prior to actuating the second locking mechanism 130, the wellhead component may not be adequately sealed with the wellhead locking device 110.

In some embodiments, the first locking mechanism 120 and the second locking mechanism 130 can be hydraulically actuated to permit the wellhead locking device 110 to hydraulically lock the wellhead components. For example, the first locking mechanism 120 can include a double acting cylinder with a piston 122. During a locking operation, hydraulic fluid flow can urge the piston 122 toward an actuated, engagement, or locked position 124. As the piston 122 moves toward the locked position 124, the first locking mechanism 120 can actuate one or more of the plurality of cams to engage the wellhead component. It should be noted that, although a single piston is shown in the figures, a different number of pistons could be used without departing from the present invention. For example, first locking mechanism 120 could include a separate piston for each of the rotatable cams.

Similarly, the second locking mechanism 130 can include a double acting cylinder with a piston 132. During a locking mechanism, hydraulic fluid flow can urge the piston 132 toward an actuated, engagement, or locked position 136. As the piston 132 moves toward the locked position 136, the second locking mechanism 130 can actuate the safety ring to retain the first locking mechanism 120 in the locked position.

As described herein, the wellhead system 100 can be configured to perform an automated hydraulic locking operation, wherein the wellhead system 100 can first direct hydraulic fluid flow to the first locking mechanism 120 to move the piston 122 toward the locked position 124, which in turn actuates one or more of the plurality of cams to engage the wellhead component. After the complete actuation of the piston 122 to the locked position 124, the wellhead system 100 can direct hydraulic fluid flow to the second locking mechanism 130 to move the piston 132 toward the locked position 136, which in turn actuates the safety ring to retain the first locking mechanism 120 in the locked position. Advantageously, by automating the hydraulic locking operation, the wellhead system 100 can simplify operation while ensuring that the first locking mechanism 120 is fully actuated prior to actuation of the second locking mechanism 130, regardless of visual line-of-sight confirmation and varying conditions, preventing inadvertent leakage, blowouts, and/or damage.

In the depicted example, a locking circuit 150 of the wellhead system 100 includes a locking sequence valve 158 to direct flow in sequence to the first locking mechanism 120 and then to the second locking mechanism 130. To initiate a locking operation, a control element of the directional control valve 140 is actuated to a locking position 144 to allow hydraulic fluid flow to enter the locking circuit 150. Optionally, the control element of the directional control valve 140 can be actuated to the locking position 144 from the stopped position 148 or the releasing position 146 using the handle 142. As one of ordinary skill in the art would readily understand, the control element does not need to be a handle but could also be a switch, a lever, a wheel, a knob, or any other component capable of controlling fluid flow through the directional control valve 140.

As illustrated, the locking circuit 150 directs hydraulic fluid flow to the first locking mechanism 120 via the first locking flow path or branch 152. As hydraulic fluid flow is directed to the first locking mechanism 120, the piston 122 is urged toward the locked position 124, actuating the first locking mechanism 120 to a locked state.

As the hydraulic fluid flow actuates the first locking mechanism 120, the locking sequence valve 158 prevents hydraulic fluid flow from entering the second locking branch 157. In the depicted example, the locking sequence valve 158 includes a valve element that remains closed until the first locking mechanism 120 is in a locked state to prevent incomplete actuation of the first locking mechanism 120.

After the hydraulic fluid flow urges the piston 122 to the locked position 124, the locking sequence valve 158 permits hydraulic fluid flow to the second locking mechanism 130 via the second locking branch 157. In the depicted example, the valve element of the locking sequence valve 158 is actuated from a closed position to an open position that allows flow from the first locking branch 152 to the second locking branch 157 via flow path 154.

The valve element of the locking sequence valve 158 is preferably actuated from the closed position to the open position in response to a change in hydraulic fluid pressure. For example, the valve element of the locking sequence valve 158 can be actuated from the closed position to the open position when the hydraulic fluid pressure exceeds a threshold fluid pressure once the piston 122 has been moved to the locked position 124, thus ensuring that first locking mechanism is in a locked state. At that point, no additional hydraulic fluid is able to flow into first locking branch 152, so further hydraulic fluid introduced into locking circuit 150 will instead cause the hydraulic fluid pressure in flow path 154 to increase until the threshold fluid pressure of locking sequence valve 158 has been exceeded.

Preferably, the threshold fluid pressure of locking sequence valve 158 can be configured based on operating conditions including temperature and desired actuation characteristics, in order to ensure that locking sequence valve 158 is not actuated from the closed position to the open position until after piston 122 has been moved to the locked position 124. The threshold fluid pressure may be field adjustable. In some embodiments, the threshold fluid pressure can be about 750 psi. Optionally, the locking sequence valve 158 can include a drain line 159 to prevent trapped fluid from inhibiting actuation of the valve element or otherwise altering the desired threshold pressure. For example, the drain line 159 can relieve pressure within the second locking branch 157 that may otherwise prevent the valve element of the locking sequence valve 158 from moving to the open position.

In some embodiments, the valve element of the locking sequence valve 158 can be actuated to the open position directly by the hydraulic fluid flow at the threshold fluid pressure. Optionally, the locking sequence valve 158 can be configured as a relief valve wherein the flow through the locking sequence valve 158 is proportional to the fluid pressure therethrough.

Therefore, during operation, after the piston 122 is urged to the locked position 124, the hydraulic fluid pressure within the locking circuit 150 can increase and exceed the threshold fluid pressure of the locking sequence valve 158. After the fluid pressure within the locking circuit 150 exceeds the threshold fluid pressure of the locking sequence valve 158, the valve element can permit hydraulic fluid flow from the first locking branch 152 to the second locking mechanism 130 via the second locking branch 157.

As hydraulic fluid flow is directed to the second locking mechanism 130, the piston 132 is urged toward the locked position 136, actuating the second locking mechanism 130 to a locked state. Advantageously, by utilizing the locking sequence valve 158, an operator can perform a multi-step hydraulic locking operation by actuating the handle 142 of the directional control valve 140, simplifying operations, eliminating the need for visual confirmation, and reducing errors.

Optionally, during operation, the wellhead system 100 can allow for trapped fluid to be released during the actuation of the first locking mechanism 120 and/or the second locking mechanism 130. For example, as the piston 122 of the first locking mechanism 120 is urged to the locked position 124, hydraulic fluid on the opposite side of the piston 122 is allowed to backflow through releasing circuit 160 to allow the piston 122 to advance. In the depicted example, trapped hydraulic fluid can exit the first locking mechanism 120 through the second releasing branch 167 to the first releasing branch 162 via a check valve 166. The check valve 166 can allow backflow from the first locking mechanism 120 to pass therethrough while preventing actuating fluid flow from bypassing the releasing sequencing valve 168. Thereafter, trapped fluid can flow from the first releasing branch 162 though the directional control valve 140 back to a hydraulic fluid source.

Similarly, as the piston 132 of the second locking mechanism 130 is urged to the locked position 136, hydraulic fluid on the opposite side of the piston 132 is allowed to backflow through the releasing circuit 160 to allow the piston 132 to advance. In the depicted example, trapped hydraulic fluid can exit the second locking mechanism 130 through the first releasing branch 162 through the directional control valve 140 back to the hydraulic fluid source.

FIG. 1B is a schematic view of the wellhead system 100 of FIG. 1A in a releasing configuration. In the depicted example, the wellhead system 100 facilitates the release of wellhead components.

In some applications, to release the wellhead component from the wellhead locking device 110, the second locking mechanism 130 can disengage the safety ring to permit the first locking mechanism 120 to move to the released position. After the second locking mechanism 130 is disengaged, the first locking mechanism 120 can rotate one or more of the plurality of rotatable cams to disengage the wellhead component. During operation, if the second locking mechanism 130 is not fully actuated or released prior to actuating the first locking mechanism 120, the wellhead component may not be fully released from the wellhead locking device 110.

In some embodiments, the first locking mechanism 120 and the second locking mechanism 130 can be hydraulically actuated to permit the wellhead locking device 110 to hydraulically release the wellhead components. During a release operation, hydraulic fluid flow directed to the second locking mechanism 130 can urge the piston 132 toward an actuated or released position 134. As the piston 132 moves toward the released position 134, the second locking mechanism 130 can actuate the safety ring to disengage from the first locking mechanism 120, permitting the first locking mechanism 120 to be actuated.

Thereafter, hydraulic fluid flow directed to the first locking mechanism 120 can urge the piston 122 toward an actuated or released position 126. As the piston 122 moves toward the released position 126, the first locking mechanism 120 can actuate one or more of the plurality of cams to release the wellhead component.

As described herein, the wellhead system 100 can be configured to perform an automated hydraulic release operation, wherein the wellhead system 100 can first direct hydraulic fluid flow to the second locking mechanism 130 to move the piston 132 toward the released position 134, which in turn actuates the safety ring to disengage from the first locking mechanism 120. After the complete actuation of the piston 132 to the released position 134, the wellhead system 100 can direct hydraulic fluid flow to the first locking mechanism 120 to move the piston 122 to the released position 126 to actuate one or more of the plurality of cams.

In the depicted example, a releasing circuit 160 of the wellhead system 100 includes a releasing sequence valve 168 to direct flow in sequence to the second locking mechanism 130 and then to the first locking mechanism 120. To initiate a release operation, the control element of the directional control valve 140 is actuated to a releasing position 146 to direct hydraulic fluid flow to enter the releasing circuit 160.

As illustrated, the releasing circuit 160 directs hydraulic fluid flow to the second locking mechanism 130 via the first releasing branch 162. As hydraulic fluid flow is directed to the second locking mechanism 130, the piston 132 is urged toward the releasing position 134, actuating the second locking mechanism 130 to a released state.

As the hydraulic fluid flow actuates the second locking mechanism 130, the releasing sequence valve 168 prevents hydraulic fluid flow from entering the second releasing branch 167. In the depicted example, the releasing sequence valve 168 includes a valve element that remains closed until the second locking mechanism 130 is in a released state to prevent incomplete actuation of the second locking mechanism 130.

After the hydraulic fluid flow urges the piston 132 to the releasing position 134, the releasing sequence valve 168 permits hydraulic fluid flow to the first locking mechanism 120 via the second releasing branch 167. In the depicted example, the valve element of the releasing sequence valve 168 is actuated from a closed position to an open position that allows flow from the first releasing branch 162 to the second releasing branch 167 via flow path 164.

Similar to the valve element of the locking sequence valve 158, the valve element of the releasing sequence valve 168 is actuated from the closed position to the open position in response to a change in hydraulic fluid pressure. For example, the valve element of the releasing sequence valve 168 can be actuated from the closed position to the open position when the hydraulic fluid pressure exceeds a threshold fluid pressure.

Therefore, during operation, after the piston 132 is urged to the releasing position 134, the hydraulic fluid pressure within the releasing circuit 160 can increase and exceed the threshold fluid pressure of the releasing sequence valve 168. After the fluid pressure within the releasing circuit 160 exceeds the threshold fluid pressure of the releasing sequence valve 168, the valve element can permit hydraulic fluid flow from the first releasing branch 162 to the first locking mechanism 120 via the second releasing branch 167. Optionally, the releasing sequence valve 168 can include a drain line 169 to prevent trapped fluid from inhibiting actuation of the valve element or otherwise altering the desired threshold pressure. For example, the drain line 169 can relieve pressure within the second releasing branch 167 that may otherwise prevent the valve element of the releasing sequence valve 168 from moving to the open position.

As hydraulic fluid flow is directed to the first locking mechanism 120, the piston 122 is urged toward the releasing position 126, actuating the first locking mechanism 120 to a released state. Advantageously, by utilizing the releasing sequence valve 168, an operator can perform a multi-step hydraulic releasing operation by actuating the handle 142 of the directional control valve 140, simplifying operations, eliminating the need for visual confirmation, and reducing errors.

Optionally, during the release operation, the wellhead system 100 can allow for trapped fluid to be released during the actuation of the second locking mechanism 130 and/or the first locking mechanism 120. For example, as the piston 132 of the second locking mechanism 130 is urged to the releasing position 134, hydraulic fluid on the opposite side of the piston 132 is allowed to backflow through locking circuit 150 to allow the piston 132 to advance. In the depicted example, trapped hydraulic fluid can exit the second locking mechanism 130 through the second locking branch 157 to the first locking branch 152 via a check valve 156. The check valve 156 can allow backflow from the second locking mechanism 130 to pass therethrough while preventing actuating fluid flow from bypassing the locking sequencing valve 158. Thereafter, trapped fluid can flow from the first locking branch 152 though the directional control valve 140 back to a hydraulic fluid source.

Similarly, as the piston 122 of the first locking mechanism 120 is urged to the releasing position 126, hydraulic fluid on the opposite side of the piston 122 is allowed to backflow through the locking circuit 150 to allow the piston 122 to advance. In the depicted example, trapped hydraulic fluid can exit the first locking mechanism 120 through the first locking branch 152 through the directional control valve 140 back to the hydraulic fluid source.

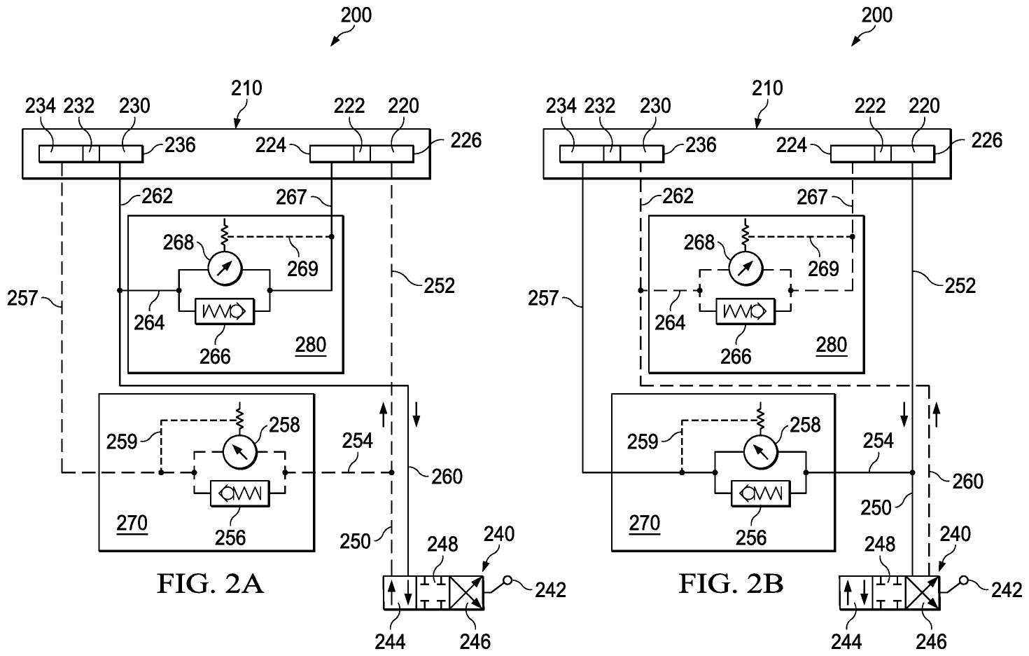

FIG. 2A is a schematic view of an embodiment of a wellhead system 200. In the illustrated embodiment, the wellhead system 200 includes features that are similar to features previously discussed with respect to wellhead system 100. Except where noted, similar features may be referred to with similar reference numerals and may reference corresponding descriptions.

In some embodiments, the locking circuit 250 can include a locking sequence valve assembly 270 to direct hydraulic fluid flow to the first locking mechanism 220 and then to the second locking mechanism 230. In the depicted example, the locking sequence valve 258 and the check valve 256 can be housed within the common locking sequence valve assembly 270. In some embodiments, the locking sequence valve 258 and the check valve 256 can be integrally formed within the common locking sequence valve assembly 270. Optionally, the locking sequence valve assembly 270 can include a hydraulic valve block including the locking sequence valve 258 and the check valve 256. Flow paths between the sequencing components can be formed within the hydraulic valve block. Advantageously, by housing the locking sequence valve 258 and the check valve 256 within the locking sequence valve assembly 270, the sequencing components can have a reduced footprint and can simplify installation.

Similar to wellhead system 100, the directional control valve 240 is actuated to a locking position 244 to allow hydraulic fluid flow to enter the locking circuit 250 to initiate a locking operation. As illustrated, the locking circuit 250 directs hydraulic fluid flow to the first locking mechanism 220 via the first locking branch 252.

As the hydraulic fluid flow actuates the first locking mechanism 220, the locking sequence valve assembly 270 prevents hydraulic fluid flow from the flow path 254 from entering the second locking branch 257. As previously described, the locking sequence valve 258 within the locking sequence valve assembly 270 includes a valve element that remains closed until the first locking mechanism 220 is in a locked state to prevent incomplete actuation of the first locking mechanism 220.

After the hydraulic fluid flow urges the piston 222 to the locked position 224, the locking sequence valve assembly 270 permits hydraulic fluid flow to the second locking mechanism 230 via the second locking branch 257. In the depicted example, the valve element of the locking sequence valve 258 is actuated from a closed position to an open position that allows flow from the flow path 254 to the second locking branch 257.

As hydraulic fluid flow is directed to the second locking mechanism 230, the piston 232 is urged toward the locked position 236, actuating the second locking mechanism 230 to a locked state.

Optionally, during operation, the wellhead system 200 can allow for trapped fluid to be released during the actuation of the first locking mechanism 220 and/or the second locking mechanism 230. In the depicted example, trapped hydraulic fluid can exit the first locking mechanism 220 through the second releasing branch 267 to the first releasing branch 262 via the release sequence valve assembly 280. A check valve 266 within the release sequence valve assembly 280 can allow backflow from the first locking mechanism 220 to pass therethrough while preventing actuating fluid flow from bypassing the releasing sequencing valve 268. Thereafter, trapped fluid can flow from the first releasing branch 262 through the directional control valve 240 back to a hydraulic fluid source.

Similarly, trapped hydraulic fluid can exit the second locking mechanism 230 through the first releasing branch 262 through the directional control valve 240 back to the hydraulic fluid source.

FIG. 2B is a schematic view of the wellhead system of FIG. 2A in a releasing configuration. In some embodiments, the releasing circuit 260 can include a releasing sequence valve assembly 280 to direct hydraulic fluid flow to the second locking mechanism 230 and then to the first locking mechanism 220. In the depicted example, the releasing sequence valve 268 and the check valve 266 can be housed within the common releasing sequence valve assembly 280. In some embodiments, the releasing sequence valve 268 and the check valve 266 can be integrally formed within the common releasing sequence valve assembly 280. Optionally, the releasing sequence valve assembly 280 can include a hydraulic valve block including the releasing sequence valve 268 and the check valve 266.

Similar to wellhead system 100, the directional control valve 240 is actuated to a releasing position 246 to allow hydraulic fluid flow to enter the releasing circuit 260 to initiate a releasing operation. As illustrated, the releasing circuit 260 directs hydraulic fluid flow to the second locking mechanism 230 via the first releasing branch 262.

As the hydraulic fluid flow actuates the second locking mechanism 230, the releasing sequence valve assembly 280 prevents hydraulic fluid flow from the flow path 264 from entering the second releasing branch 267. As previously described, the releasing sequence valve 268 within the releasing sequence valve assembly 280 includes a valve element that remains closed until the second locking mechanism 230 is in a released state to prevent incomplete actuation of the second locking mechanism 230.

After the hydraulic fluid flow urges the piston 232 to the releasing position 234, the releasing sequence valve assembly 280 permits hydraulic fluid flow to the first locking mechanism 220 via the second releasing branch 267. In the depicted example, the valve element of the releasing sequence valve 268 is actuated from a closed position to an open position that allows flow from the flow path 264 to the second releasing branch 267.

As hydraulic fluid flow is directed to the first locking mechanism 220, the piston 222 is urged toward the releasing position 226, actuating the first locking mechanism 220 to a released state.

Optionally, during the release operation, the wellhead system 200 can allow for trapped fluid to be released during the actuation of the second locking mechanism 230 and/or the first locking mechanism 220. In the depicted example, trapped hydraulic fluid can exit the second locking mechanism 230 through the second locking branch 257 to the first locking branch 252 via the locking sequence valve assembly 270. A check valve 256 within the locking sequence valve assembly 270 can allow backflow from the second locking mechanism 230 to pass therethrough while preventing actuating fluid flow from bypassing the locking sequencing valve 258. Thereafter, trapped fluid can flow from the first locking branch 252 through the directional control valve 240 back to a hydraulic fluid source.

Similarly, trapped hydraulic fluid can exit the first locking mechanism 220 through the first locking branch 252 through the directional control valve 240 back to the hydraulic fluid source.

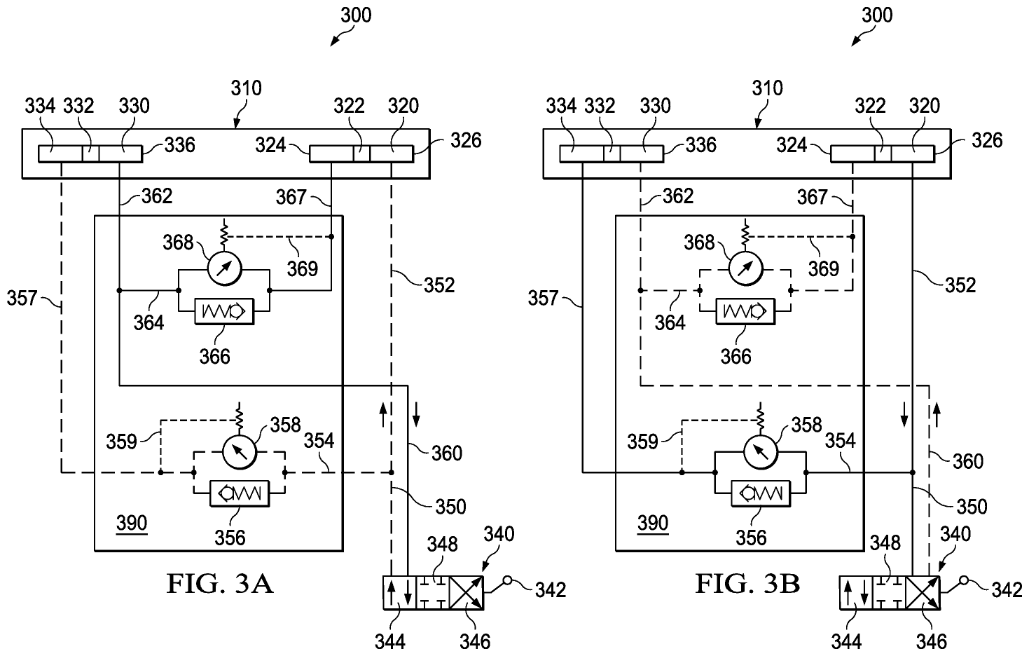

FIG. 3A is a schematic view of an embodiment of a wellhead system 300. In the illustrated embodiment, the wellhead system 300 includes features that are similar to features previously discussed with respect to wellhead system 100. Except where noted, similar features may be referred to with similar reference numerals and may reference corresponding descriptions.

In some embodiments, the wellhead system 300 can include a sequence valve assembly 390 to direct hydraulic fluid flow to the first locking mechanism 320 and to the second locking mechanism 330 in a desired sequence to either lock components to the wellhead device 310 or to release components from the wellhead device 310. In the depicted example, the sequence valve assembly 390 includes a locking sequence valve 358, a corresponding check valve 356, a releasing sequence valve 368, and a corresponding check valve 366. In some embodiments, the locking sequence valve 358, the corresponding check valve 356, the releasing sequence valve 368, and the corresponding check valve 366 can be integrally formed within the common sequence valve assembly 390. Optionally, the sequence valve assembly 390 can include a hydraulic valve block including the locking sequence valve 358, the corresponding check valve 356, the releasing sequence valve 368, and the corresponding check valve 366. Advantageously, by housing the locking sequence valve 358, the corresponding check valve 356, the releasing sequence valve 368, and the corresponding check valve 366 within the sequence valve assembly 390, the sequencing components can have a reduced footprint and can simplify installation. As illustrated, the sequence valve assembly 390 is in fluid communication with the locking circuit 350 and the releasing circuit 360.

In a locking operation, the directional control valve 340 is actuated to a locking position 344 to allow hydraulic fluid flow to enter the locking circuit 350. As illustrated, the locking circuit 350 directs hydraulic fluid flow to the first locking mechanism 320 via the first locking branch 352.

As the hydraulic fluid flow actuates the first locking mechanism 320, the sequence valve assembly 390 prevents hydraulic fluid flow from the flow path 354 from entering the second locking branch 357. As previously described, the locking sequence valve 358 within the sequence valve assembly 390 includes a valve element that remains closed until the first locking mechanism 320 is in a locked state to prevent incomplete actuation of the first locking mechanism 320.

After the hydraulic fluid flow urges the piston 322 to the locked position 324, the sequence valve assembly 390 permits hydraulic fluid flow to the second locking mechanism 330 via the second locking branch 357. In the depicted example, the valve element of the locking sequence valve 358 is actuated from a closed position to an open position that allows flow from the flow path 354 to the second locking branch 357.

As hydraulic fluid flow is directed to the second locking mechanism 330, the piston 332 is urged toward the locked position 336, actuating the second locking mechanism 330 to a locked state.

Optionally, during operation, the wellhead system 300 can allow for trapped fluid to be released during the actuation of the first locking mechanism 320 and/or the second locking mechanism 330. In the depicted example, trapped hydraulic fluid can exit the first locking mechanism 320 through the second releasing branch 367 to the first releasing branch 362 via the sequence valve assembly 390. A check valve 366, corresponding to the releasing sequence valve 368, within the sequence valve assembly 390 can allow backflow from the first locking mechanism 320 to pass therethrough while preventing actuating fluid flow from bypassing the releasing sequence valve 368. Thereafter, trapped fluid can flow from the first releasing branch 362 though the directional control valve 340 back to a hydraulic fluid source.

Similarly, trapped hydraulic fluid can exit the second locking mechanism 330 through the first releasing branch 362 via the sequence valve assembly 390 through the directional control valve 340 back to the hydraulic fluid source.

FIG. 3B is a schematic view of the wellhead system of FIG. 3A in a releasing configuration.

In a releasing operation, the directional control valve 340 is actuated to a releasing position 346 to allow hydraulic fluid flow to enter the releasing circuit 360. As illustrated, the releasing circuit 360 directs hydraulic fluid flow to the second locking mechanism 330 via the first releasing branch 362. In some embodiments, the first releasing branch 362 is at least partially disposed or formed within the sequence valve assembly 390.

As the hydraulic fluid flow actuates the second locking mechanism 330, the sequence valve assembly 390 prevents hydraulic fluid flow from the first releasing branch 362 from entering the second releasing branch 367. As previously described, the releasing sequence valve 368 within the sequence valve assembly 390 includes a valve element that remains closed until the second locking mechanism 330 is in a released state to prevent incomplete actuation of the second locking mechanism 330.

After the hydraulic fluid flow urges the piston 332 to the releasing position 334, the sequence valve assembly 390 permits hydraulic fluid flow to the first locking mechanism 320 via the second releasing branch 367. In some embodiments, the second releasing branch 367 is at least partially disposed or formed within the sequence valve assembly 390. In the depicted example, the valve element of the releasing sequence valve 368 is actuated from a closed position to an open position that allows flow from the flow path 364 to the second releasing branch 367.

As hydraulic fluid flow is directed to the first locking mechanism 320, the piston 322 is urged toward the releasing position 326, actuating the first locking mechanism 320 to a released state.

Optionally, during the release operation, the wellhead system 300 can allow for trapped fluid to be released during the actuation of the second locking mechanism 330 and/or the first locking mechanism 320. In the depicted example, trapped hydraulic fluid can exit the second locking mechanism 330 through the second locking branch 357 to the first locking branch 352 via the sequence valve assembly 390. A check valve 356, corresponding to the locking sequence valve 358, within the sequence valve assembly 390 can allow backflow from the second locking mechanism 330 to pass therethrough while preventing actuating fluid flow from bypassing the locking sequencing valve 358. Thereafter, trapped fluid can flow from the first locking branch 352 though the directional control valve 340 back to a hydraulic fluid source.

Similarly, trapped hydraulic fluid can exit the first locking mechanism 320 through the first locking branch 352 through the directional control valve 340 back to the hydraulic fluid source.

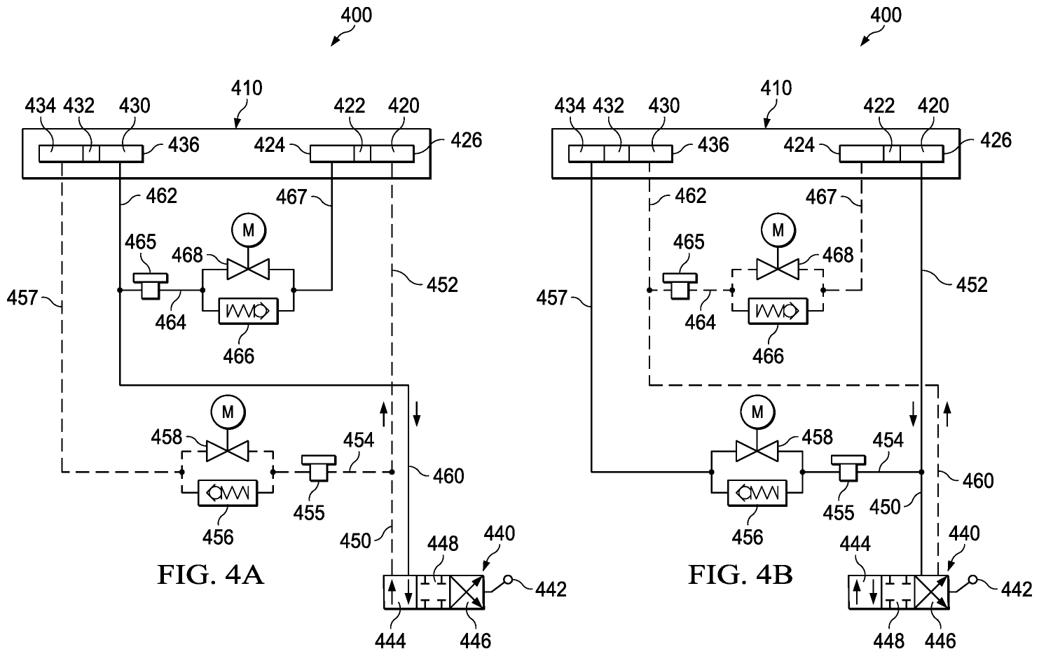

FIG. 4A is a schematic view of an embodiment of a wellhead system 400. In the illustrated embodiment, the wellhead system 400 includes features that are similar to features previously discussed with respect to wellhead system 100. Except where noted, similar features may be referred to with similar reference numerals and may reference corresponding descriptions. In some embodiments, the wellhead system 400 can include externally actuated valves that may not be directly actuated by fluid pressure experienced by the valve.

For example, the wellhead system 400 may include an electromechanically actuated locking sequence valve 458 to direct flow in sequence to the first locking mechanism 420 and then to the second locking mechanism 430. Similar to locking sequence valve 158, as the hydraulic fluid flow actuates the first locking mechanism 420, the electromechanically actuated locking sequence valve 458 can prevent hydraulic fluid flow from entering the second locking branch 457. In the depicted example, the electromechanically actuated locking sequence valve 458 includes a valve element that remains closed until the first locking mechanism 420 is in a locked state to prevent incomplete actuation of the first locking mechanism 420.

After the hydraulic fluid flow urges the piston 422 to the locked position 424, the electromechanically actuated locking sequence valve 458 permits hydraulic fluid flow to the second locking mechanism 430 via the second locking branch 457. In the depicted example, the valve element of the electromechanically actuated locking sequence valve 458 is actuated from a closed position to an open position that allows flow from the first locking branch 452 to the second locking branch 457 via flow path 454.

In the depicted example, the valve element of the electromechanically actuated locking sequence valve 458 is actuated by a motor M.

Optionally, the electromechanically actuated locking sequence valve 458 can be configured to be actuated from the closed position to the open position in response to a change in hydraulic fluid pressure. Hydraulic fluid pressure within the flow path 454 can be measured by a pressure sensor 455. In response to the measured pressure, the valve element of the electromechanically actuated locking sequence valve 458 can be actuated from the closed position to the open position when the hydraulic fluid pressure exceeds a threshold fluid pressure once the piston 422 has been moved to the locked position 424, thus ensuring that first locking mechanism 420 is in a locked state. At that point, no additional hydraulic fluid is able to flow into first locking branch 452, so further hydraulic fluid introduced into locking circuit 450 will instead cause the hydraulic fluid pressure in flow path 454 to increase until the threshold fluid pressure experienced by the pressure sensor 455 has been exceeded.

Preferably, the threshold fluid pressure of experienced by the pressure sensor 455 can be configured based on operating conditions including temperature and desired actuation characteristics, in order to ensure that electromechanically actuated locking sequence valve 458 is not actuated from the closed position to the open position until after piston 422 has been moved to the locked position 424. The threshold fluid pressure may be field adjustable. In some embodiments, the threshold fluid pressure can be about 750 psi.

FIG. 4B is a schematic view of the wellhead system 400 of FIG. 4A in a releasing configuration. In some embodiments, the wellhead system 400 can include an electromechanically actuated releasing sequence valve 468 to direct flow in sequence to the second locking mechanism 430 and then to the first locking mechanism 420.

Similar to electromechanically actuated locking sequence valve 458, as the hydraulic fluid flow actuates the second locking mechanism 430, the electromechanically actuated releasing sequence valve 468 prevents hydraulic fluid flow from entering the second releasing branch 467. In the depicted example, the electromechanically actuated releasing sequence valve 468 includes a valve element that remains closed until the second locking mechanism 430 is in a released state to prevent incomplete actuation of the second locking mechanism 430.

After the hydraulic fluid flow urges the piston 432 to the releasing position 434, the electromechanically actuated releasing sequence valve 468 permits hydraulic fluid flow to the first locking mechanism 420 via the second releasing branch 467. In the depicted example, the valve element of the electromechanically actuated releasing sequence valve 468 is actuated from a closed position to an open position that allows flow from the first releasing branch 462 to the second releasing branch 467 via flow path 464.

Similar to the valve element of the electromechanically locking sequence valve 458, the valve element of the electromechanically actuated releasing sequence valve 468 is actuated by a motor M.

As described herein, the electromechanically actuated releasing sequence valve 468 can be actuated from the closed position to the open position in response to a change in hydraulic fluid pressure. Hydraulic fluid pressure within the flow path 464 can be measured by a pressure sensor 465. Therefore, the valve element of the electromechanically actuated releasing sequence valve 468 can be actuated from the closed position to the open position when the hydraulic fluid pressure as measured by the pressure sensor 465 exceeds a threshold fluid pressure.

Therefore, during operation, after the piston 432 is urged to the releasing position 434, the hydraulic fluid pressure within the releasing circuit 460 can increase and exceed the threshold fluid pressure as experienced by the pressure sensor 465. After the fluid pressure within the releasing circuit 460 exceeds the threshold fluid pressure experienced by the pressure sensor 465, the electromechanically actuated releasing sequence valve 468 can actuate the valve element to permit hydraulic fluid flow from the first releasing branch 462 to the first locking mechanism 420 via the second releasing branch 467.

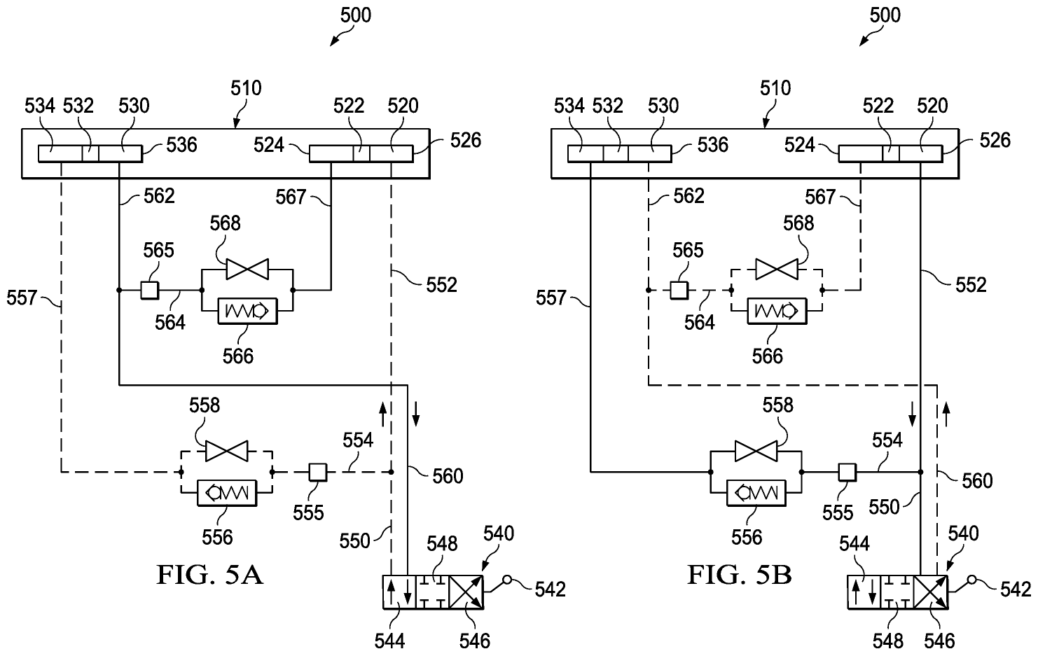

FIG. 5A is a schematic view of an embodiment of a wellhead system 500. In the illustrated embodiment, the wellhead system 500 includes features that are similar to features previously discussed with respect to wellhead system 100. Except where noted, similar features may be referred to with similar reference numerals and may reference corresponding descriptions.

In some embodiments, the wellhead system 500 can include a mechanically actuated locking sequence valve 558 to direct flow in sequence to the first locking mechanism 520 and then to the second locking mechanism 530. Similar to locking sequence valve 158, as the hydraulic fluid flow actuates the first locking mechanism 520, the mechanically actuated locking sequence valve 558 can prevent hydraulic fluid flow from entering the second locking branch 557. In the depicted example, the mechanically actuated locking sequence valve 558 includes a valve element that remains closed until the first locking mechanism 520 is in a locked state to prevent incomplete actuation of the first locking mechanism 520.

After the hydraulic fluid flow urges the piston 522 to the locked position 524, the mechanically actuated locking sequence valve 558 permits hydraulic fluid flow to the second locking mechanism 530 via the second locking branch 557. In the depicted example, the valve element of the mechanically actuated locking sequence valve 558 is actuated from a closed position to an open position that allows flow from the first locking branch 552 to the second locking branch 557 via flow path 554.

In the depicted example, the valve element of the mechanically actuated locking sequence valve 558 is actuated by a spring or a linkage (not shown).

Optionally, the mechanically actuated locking sequence valve 558 can be triggered to be actuated from the closed position to the open position in response to a change in hydraulic fluid pressure. For example, a pressure trigger 555 can be in fluid communication with the flow path 554 and can trigger the actuation of the mechanically actuated locking sequence valve 558. Therefore, the valve element of the mechanically actuated locking sequence valve 558 can be actuated from the closed position to the open position when the hydraulic fluid pressure as experienced by the pressure trigger 555 exceeds a threshold fluid pressure once the piston 522 has been moved to the locked position 524, thus ensuring that first locking mechanism 520 is in a locked state. At that point, no additional hydraulic fluid is able to flow into first locking branch 552, so further hydraulic fluid introduced into locking circuit 550 will instead cause the hydraulic fluid pressure in flow path 554 to increase until the threshold fluid pressure experienced by the pressure trigger 555 has been exceeded.

Preferably, the threshold fluid pressure of experienced by the pressure trigger 555 can be configured based on operating conditions including temperature and desired actuation characteristics, in order to ensure that mechanically actuated locking sequence valve 558 is not actuated from the closed position to the open position until after piston 522 has been moved to the locked position 524. The threshold fluid pressure may be field adjustable. In some embodiments, the threshold fluid pressure can be about 750 psi.

FIG. 5B is a schematic view of the wellhead system 500 of FIG. 5A in a releasing configuration. In some embodiments, the wellhead system 500 can include a mechanically actuated releasing sequence valve 568 to direct flow in sequence to the second locking mechanism 530 and then to the first locking mechanism 520.

Similar to mechanically actuated locking sequence valve 558, as the hydraulic fluid flow actuates the second locking mechanism 530, the mechanically actuated releasing sequence valve 568 prevents hydraulic fluid flow from entering the second releasing branch 567. In the depicted example, the mechanically actuated releasing sequence valve 568 includes a valve element that remains closed until the second locking mechanism 530 is in a released state to prevent incomplete actuation of the second locking mechanism 530.

After the hydraulic fluid flow urges the piston 532 to the releasing position 534, the mechanically actuated releasing sequence valve 568 permits hydraulic fluid flow to the first locking mechanism 520 via the second releasing branch 567. In the depicted example, the valve element of the mechanically actuated releasing sequence valve 568 is actuated from a closed position to an open position that allows flow from the first releasing branch 562 to the second releasing branch 567 via flow path 564.

Similar to the valve element of the mechanically locking sequence valve 558, the valve element of the mechanically actuated releasing sequence valve 568 is actuated by a spring or a linkage (not shown).

As described herein, the mechanically actuated releasing sequence valve 568 can be actuated from the closed position to the open position in response to a change in hydraulic fluid pressure. For example, a pressure trigger 565 can be in fluid communication with the flow path 564 and can trigger the actuation of the mechanically actuated releasing sequence valve 568. Therefore, the valve element of the mechanically actuated releasing sequence valve 568 can be actuated from the closed position to the open position when the hydraulic fluid pressure as experienced by the pressure trigger 565 exceeds a threshold fluid pressure.

Therefore, during operation, after the piston 532 is urged to the releasing position 534, the hydraulic fluid pressure within the releasing circuit 560 can increase and exceed the threshold fluid pressure as experienced by the pressure trigger 565. After the fluid pressure within the releasing circuit 560 exceeds the threshold fluid pressure experienced by the pressure trigger 565, the mechanically actuated releasing sequence valve 568 can actuate the valve element to permit hydraulic fluid flow from the first releasing branch 562 to the first locking mechanism 520 via the second releasing branch 567.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A wellhead system configured to control a wellhead device with a first locking device and a second locking device, said locking devices each independently movable between an engagement position and a released position and the wellhead system comprising:
a first sequence valve in fluid communication with the first locking device via a first flow path and the second locking device via a second flow path, the first sequence valve comprising a first valve element, wherein the first valve element is configured to direct flow in the first flow path to the first locking device in a closed position and is configured to permit flow from the first flow path to the second locking device via the second flow path in an open position and the first valve element is actuated from the closed position to the open position in response to pressurizing the first flow path to a first threshold pressure.

2. The wellhead system of claim 1, wherein the first sequence valve comprises a relief valve.

3. The wellhead system of claim 1, wherein the first valve element is configured to direct flow in the first flow path to the first locking device in the closed position to actuate the first locking device to the engagement position.

4. The wellhead system of claim 1, wherein the first valve element is configured to permit flow from the first flow path to the second locking device via the second flow path in the open position to actuate the second locking device to the engagement position.

5. The wellhead system of claim 1, further comprising:
a first check valve in fluid communication with the first flow path and the second flow path, wherein the first check valve is configured to permit backflow from the second flow path to the first flow path.

6. The wellhead system of claim 5, further comprising a first sequence valve block comprising the first sequence valve and the first check valve.

7. The wellhead system of claim 1, wherein the first valve element is electromechanically actuated.

8. The wellhead system of claim 7, further comprising a pressure sensor in fluid communication with the first flow path.

9. The wellhead system of claim 1, further comprising:
a second sequence valve in fluid communication with the second locking device via a third flow path and the first locking device via a fourth flow path, the second sequence valve comprising a second valve element, wherein the second valve element is configured to direct flow in the third flow path to the second locking device in the closed position and is configured to permit flow from the third flow path to the first locking device via the fourth flow path in the open position, and the second valve element is actuated from the closed position to the open position in response to pressurizing the third flow path to a second threshold pressure.

10. The wellhead system of claim 9, wherein the second valve element is configured to direct flow in the third flow path to the second locking device in the closed position to actuate the second locking device to the released position.

11. The wellhead system of claim 9, wherein the second valve element is configured to permit flow from the third flow path to the first locking device via the fourth flow path in the open position to actuate the first locking device to the released position.

12. The wellhead system of claim 9, further comprising:
a second check valve in fluid communication with the third flow path and the fourth flow path, wherein the second check valve is configured to permit backflow from the fourth flow path to the third flow path.

13. The wellhead system of claim 12, further comprising a second sequence valve block comprising the second sequence valve and the second check valve.

14. The wellhead system of claim 12, further comprising an integrated sequence valve block comprising the first sequence valve and the second sequence valve.

15. The wellhead system of claim 9, further comprising:
a directional control valve in fluid communication with the first locking device, the second locking device, the first sequence valve, and the second sequence valve, the directional control valve comprising a control element, wherein the control element is configured to direct flow to the first locking device and the first sequence valve via the first flow path in a first control position and is configured to direct flow to the second locking device and the second sequence valve via the third flow path in a second control position, and the control element is movable between the first control position and the second control position.

16. A wellhead system, comprising:
a first locking device comprising a first piston hydraulically movable between a locked position and a released position;
a second locking device comprising a second piston hydraulically movable between a locked position and a released position;
wherein said locking devices are each independently movable between the locked position and the released position; and
a first sequence valve in fluid communication with the first locking device via a first flow path and the second locking device via a second flow path, the first sequence valve comprising a first valve element, wherein the first valve element is configured to direct flow in the first flow path to the first locking device in a closed position to move the first piston to the locked position, and is configured to permit flow from the first flow path to the second locking device via the second flow path in an open position to move the second piston to the locked position, and the first valve element is actuated from the closed position to the open position in response to pressurizing the first flow path to a first threshold pressure.

17. The wellhead system of claim 16, wherein the first sequence valve is configured such that the first valve element does not move from the closed position to the open position until after the first piston has moved to the locked position.

18. The wellhead system of claim 16, further comprising:
a second sequence valve in fluid communication with the second locking device via a third flow path and the first locking device via a fourth flow path, the second sequence valve comprising a second valve element, wherein the second valve element is configured to direct flow in the third flow path to the second locking device in the closed position to move the second piston to the released position and is configured to permit flow from the third flow path to the first locking device via the fourth flow path in the open position to move the first piston to the released position, and the second valve element is actuated from the closed position to the open position in response to pressurizing the third flow path to a second threshold pressure.

19. A method to control a wellhead device, the method comprising:
directing a hydraulic fluid flow to a first locking device;
actuating a first piston of the first locking device toward an actuated position with the hydraulic fluid flow;
increasing a fluid pressure of the hydraulic fluid flow to a first threshold pressure;
actuating a first sequence valve with the hydraulic fluid flow at the threshold pressure to direct the hydraulic fluid flow to a second locking device; and
actuating a second piston of the second locking device toward an actuated position, independent of the actuated position of the first locking device, with the hydraulic fluid flow.

20. The method of claim 19, further comprising:
directing the hydraulic fluid flow to the second locking device;
actuating the second piston of the second locking device toward an opposite actuated position with the hydraulic fluid flow;
increasing the fluid pressure of the hydraulic fluid flow to a second threshold pressure;
actuating a second sequence valve with the hydraulic fluid flow at the second threshold pressure to direct the hydraulic fluid flow to the first locking device; and
actuating the first piston of the first locking device toward an opposite actuated position with the hydraulic fluid flow.
